(19) United States
(12) Patent Application Publication
(10) Pub. No.: US 2021/0053443 A1
(43) Pub. Date: Feb. 25, 2021

(54) POWER CONTROLLER

(71) Applicant: TOYOTA JIDOSHA KABUSHIKI KAISHA, Toyota-shi (JP)

(72) Inventors: Masayuki SUGITA, Nagakute-shi (JP); Koichi SAKATA, Okazaki-shi (JP); Masatoshi SHINOHARA, Toyota-shi (JP)

(73) Assignee: TOYOTA JIDOSHA KABUSHIKI KAISHA, Toyota-shi (JP)

(21) Appl. No.: 16/933,747

(22) Filed: Jul. 20, 2020

(30) Foreign Application Priority Data
Aug. 21, 2019 (JP) 2019-151352

(51) Int. Cl. B60L 1/00; B60L 50/51; B60L 15/20

(52) U.S. Cl. CPC B60L 1/003; B60L 50/51; B60L 15/2054; B60K 6/48; B60L 2240/42; B60L 2240/50; B60L 2210/40

(57) ABSTRACT

A power controller for an electric vehicle may include: an input terminal connected to a DC power source; a first inverter connected to the input terminal and configured to convert power of the DC power source to driving power for a first electric motor for propulsion; a second inverter connected to the input terminal and configured to convert the power of the DC power source to driving power for a second electric motor; and a switch configured to electrically disconnect the second inverter from the first inverter and the input terminal.

### CROSS-REFERENCE TO RELATED APPLICATION

This application claims priority to Japanese Patent Application No. 2019-151352 filed on Aug. 21, 2019, the contents of which are hereby incorporated by reference into the present application.

### TECHNICAL FIELD

The teaching disclosed herein relates to a power controller that is installed on an electric vehicle and is configured to convert power of a DC power source to driving power for an electric motor for propulsion. The “electric vehicle” mentioned herein includes a hybrid vehicle including both of an electric motor and an engine, and a fuel-cell vehicle. The “electric motor for propulsion” mentioned herein may be termed the “electric traction motor” in other words.

### BACKGROUND

An electric vehicle includes a power controller configured to convert power of a DC power source to driving power for an electric motor for propulsion. The power controller includes an inverter as its main device. Japanese Patent Application Publication No. 2015-023772 describes a power controller including two inverters. The first inverter is configured to supply power to an electric motor for propulsion. The second inverter is configured to supply power to an electric motor of an oil pump.

### SUMMARY

An electric vehicle may include an electric motor in addition to an electric motor for propulsion. In such a case, the electric vehicle includes a power controller including two inverters, as described in Japanese Patent Application Publication No. 2015-023772. For convenience of description, the electric motor for propulsion (the electric traction motor) will hereinafter be termed a first electric motor, and the other electric motor will hereinafter be termed a second electric motor. Moreover, an inverter configured to convert power of a DC power source to driving power for the first electric motor will be termed a first inverter, and the other inverter configured to convert the power of the DC power source to driving power for the second electric motor will be termed a second inverter.

If a short circuit occurs in the second inverter in a configuration where the first and second inverters are electrically connected to each other, not only the second inverter but also the first inverter could go unusable. With the unusable first electric motor, the electric vehicle cannot achieve propulsion by the first electric motor. The disclosure herein relates to a power controller including two inverters, and provides teaching that enables use of a first inverter even when a short circuit occurs in a second inverter.

A power controller disclosed herein may comprise: an input terminal connected to a DC power source; a first inverter connected to the input terminal and configured to convert power of the DC power source to driving power for a first electric motor for propulsion; a second inverter connected to the input terminal and configured to convert the power of the DC power source to driving power for a second electric motor; and a switch configured to electrically disconnect the second inverter from the first inverter and the input terminal. The first and the second inverters are electrically connected to each other.

In the power controller disclosed herein, the switch can electrically disconnect the second inverter from the first inverter and the input terminal when a short circuit occurs in the second inverter. The power controller can thus use the first inverter even when a short circuit occurs in the second inverter. An electric vehicle with this power controller can achieve propulsion by the first electric motor even when a short circuit occurs in the second inverter. The switch may be any of a mechanical relay, a semiconductor switch, and a fuse.

Details and further improvements of the technique disclosed herein will be described in Detailed Description below.

### BRIEF DESCRIPTION OF DRAWINGS

FIG. 1 is a block diagram of a drive-train of an electric vehicle including a power controller of an embodiment.

FIG. 2 is a block diagram of a drive-train of an electric vehicle including a power controller of a first variant.

FIG. 3 is a block diagram of a drive-train of an electric vehicle including a power controller of a second variant.

### DETAILED DESCRIPTION

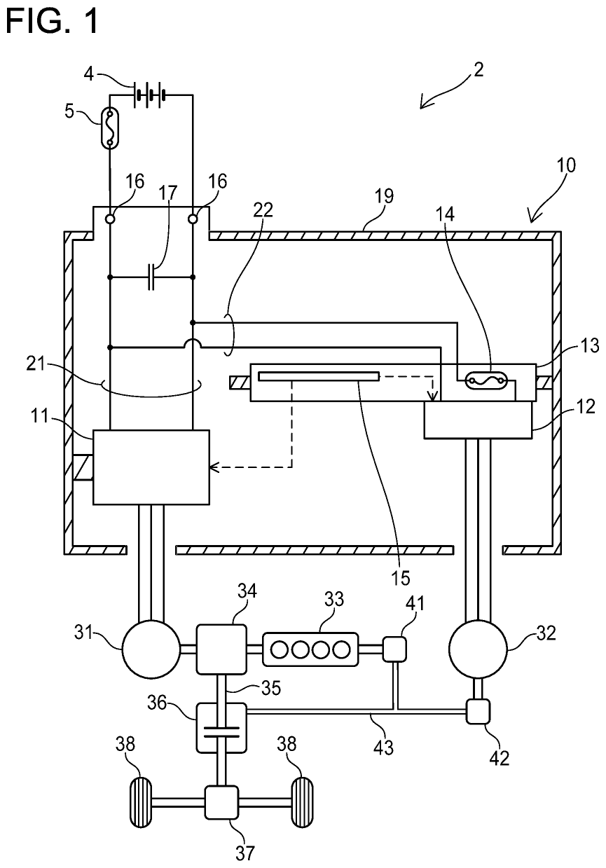

With reference to FIG. 1, a power controller 10 of an embodiment will be described. FIG. 1 is a block diagram of a drive-train of an electric vehicle 2 including the power controller 10. The electric vehicle 2 is a hybrid vehicle including an electric motor for propulsion (a first electric motor 31) and an engine 33. Output shafts of the first electric motor 31 and the engine 33 are coupled to a gear set 34. An output shaft 35 of the gear set 34 is coupled to wheels 38 via a clutch 36 and a differential gear 37. The gear set 34 is configured to combine torque of the first electric motor 31 and torque of the engine 33, and transfer the combined torque to the output shaft 35.

The clutch 36 is a device configured to disconnect the wheels 38 from the first electric motor 31 and the engine 33. The clutch 36 is controlled hydraulically. A first hydraulic pump 41 and a second hydraulic pump 42 are coupled to the clutch 36 via an oil passage 43. The first hydraulic pump 41 is driven by the engine 33. The second hydraulic pump 42 is driven by a second electric motor 32. The clutch 36 can be controlled when any one of the first hydraulic pump 41 (the engine 33) and the second hydraulic pump 42 (the second electric motor 32) is driven.

Both of the first electric motor 31 and the second electric motor 32 are supplied with power from the power controller 10. The power controller 10 is configured to convert power of a battery 4 to driving power for each of the first electric motor 31 and the second electric motor 32. The battery 4 has an output voltage equal to or more than 100 volts, and its maximum output power exceeds 10 kilowatts. The first electric motor 31 is configured to drive the wheels 38, and its maximum output current exceeds 100 amperes. On the other hand, the second electric motor 32 is configured to drive the second hydraulic pump 42, and its maximum output current is equal to or less than 10 amperes, for example. In other words, the maximum output current of the second electric motor 32 is equal to or less than one-tenth of the maximum output current of the first electric motor 31.

The power controller 10 includes a first inverter 11, a second inverter 12, and a circuit board 13. The first inverter 11 is configured to convert the power of the battery 4 to the driving power for the first electric motor 31. The second inverter 12 is configured to convert the power of the battery 4 to the driving power for the second electric motor 32. Each of the first electric motor 31 and the second electric motor 32 is a three-phase AC motor. Each of the first inverter 11 and the second inverter 12 is a device configured to convert DC power to AC power.

As described before, the maximum output current of the second electric motor 32 is equal to or less than one-tenth of the maximum output current of the first electric motor 31. Thus, a maximum output current of the second inverter 12 is equal to or less than one-tenth of a maximum output current of the first inverter 11.

The maximum output current of the first inverter 11 is larger than the maximum output current of the second inverter 12. An amount of heat generated by the first inverter 11 is also larger than an amount of heat generated by the second inverter 12. Although not shown, the first inverter 11 has a cooler attached thereto. For example, the first inverter 11 includes a plurality of coolers and a plurality of power modules respectively housing switching elements for power conversion. The power modules and the coolers are alternately stacked one by one. Both surfaces of each power module are in contact with the coolers. Description for a detailed structure of the first inverter 11 is omitted.

A control circuit 15 configured to control the first inverter 11 and the second inverter 12 is mounted on the circuit board 13. Dashed arrows in FIG. 1 indicate signal flows. Since the maximum output current of the second inverter 12 is smaller, an amount of heat generated by the second inverter 12 is also smaller. The second inverter 12 is thus fixed directly to the circuit board 13. The circuit board 13 is fixed to a housing 19 of the power controller 10. On the other hand, since the amount of heat generated by the first inverter 11 is larger, the first inverter 11 is fixed directly to the housing 19, separately from the circuit board 13. Details for the structure of the second inverter 12 are omitted.

The first inverter 11 is connected to an input terminal 16 of the power controller 10 via a main power line 21. The second inverter 12 is connected to the input terminal 16 via an auxiliary power line 22 and the main power line 21. The input terminal 16 of the power controller 10 is connected to the battery 4. The auxiliary power line 22 is connected to an intermediate portion of the main power line 21. As described before, the maximum output current of the second inverter 12 is equal to or less than one-tenth of the maximum output current of the first inverter 11. Thus, an allowable current of the auxiliary power line 22 may be equal to or less than one-tenth of an allowable current of the main power line 21, and a thickness of the auxiliary power line 22 is smaller than a thickness of the main power line 21.

A smoothing capacitor 17 is connected between positive and negative lines of the main power line 21. The smoothing capacitor 17 suppresses a ripple of current flowing in the main power line 21.

The auxiliary power line 22 passes through the circuit board 13 and is connected to the second inverter 12. A fuse 14 is mounted on the circuit board 13. The fuse 14 is incorporated in the auxiliary power line 22. The fuse 14 is configured to blow when an overcurrent flows to electrically disconnect the second inverter 12 from the first inverter 11 and the input terminal 16 (i.e., the battery 4).

A typical example of a case where an overcurrent flows in the second inverter 12 is when a short circuit occurs in the second inverter 12 or in the second electric motor 32. If the second inverter 12 or the second electric motor 32 in which a short circuit has occurred remains connected to the first inverter 11 (and the input terminal 16), not only the second inverter 12 but also the first inverter 11 could go unusable. With the unusable first electric motor 31, the wheels 38 cannot be driven by the first electric motor 31. In other words, the electric vehicle 2 cannot achieve propulsion by the first electric motor 31. Disconnecting the short-circuited second inverter 12 or second electric motor 32 from the first inverter 11 (and the input terminal 16) by the fuse 14 blowing keeps the first inverter 11 usable. In other words, the fuse 14 keeps the first inverter 11 (the first electric motor 31) usable even when a failure occurs in the second inverter 12 or the second electric motor 32.

A fuse 5 is also connected between the battery 4 and the input terminal 16. The fuse 5 is configured to blow when an overcurrent flows in the first inverter 11. Since the maximum output current of the second inverter 12 (the allowable current of the auxiliary power line 22) is equal to or less than one-tenth of the maximum output current of the first inverter 11 (the allowable current of the main power line 21), an allowable current of the fuse 14 may be equal to or less than one-tenth of an allowable current of the fuse 5. When a short circuit occurs in the second inverter 12 (the second electric motor 32), the fuse 14 blows prior to the fuse 5. Since the fuse 5 does not blow after the occurrence of short circuit in the second inverter 12 (the second electric motor 32), the first inverter 11 can keep supplied with the power from the battery 4.

When a short circuit occurs in the second inverter 12 or the second electric motor 32, the fuse 14 electrically disconnects it from the first inverter 11 and the input terminal 16 to protect the first inverter 11.

As described before, the second electric motor 32 drives the second hydraulic pump 42. The clutch 36 can be controlled when any one of the first hydraulic pump 41 and the second hydraulic pump 42 is driven. When the second electric motor 32 (the second hydraulic pump 42) is unusable, the clutch 36 can be controlled by the first hydraulic pump 41 being driven by the engine 33.

Other features of the power controller 10 of the embodiment will be described below. The fuse 14 is mounted on the circuit board 13 on which the control circuit 15 is mounted. As described before, the control circuit 15 is configured to control the first inverter 11 and the second inverter 12. The second inverter 12 is fixed to the circuit board 13. Mounting the fuse 14 for the electrical disconnection of the second inverter 12 on the circuit board 13 reduces work and costs for incorporating the fuse 14.

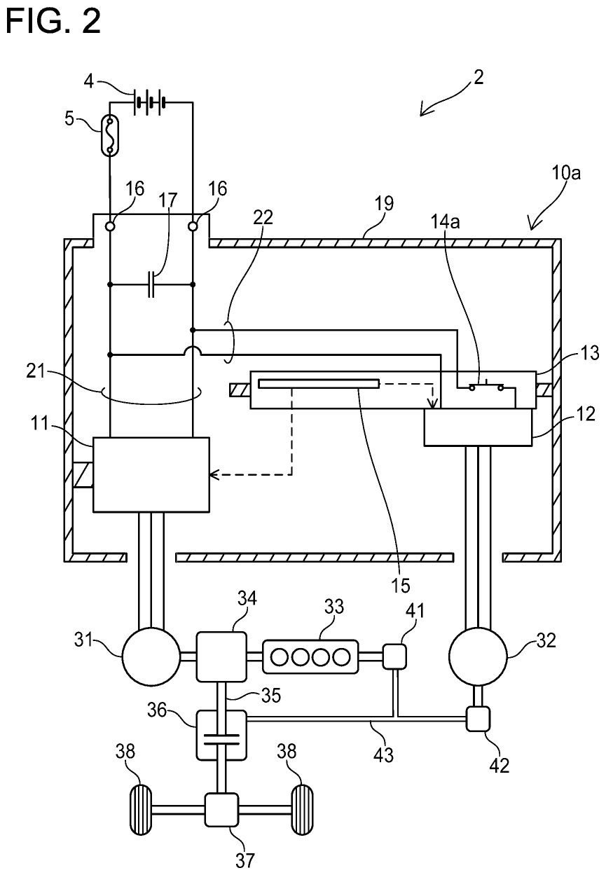

(First Variant) FIG. 2 shows a power controller 10a of a first variant. The power controller 10a includes a relay switch 14a instead of the fuse 14. The relay switch 14a is mounted on the circuit board 13. The relay switch 14a is controlled by the control circuit 15 mounted on the circuit board 13. The control circuit 15 is configured to open the relay switch 14a when a short circuit occurs in the second inverter 12 or in the second electric motor 32 to electrically disconnect the second inverter 12 and the second electric motor 32 from the first inverter 11 and the input terminal 16. The relay switch 14a has the same advantages as those of the fuse 14 of the power controller 10 of the embodiment. The relay switch 14a may be of a normally-open type.

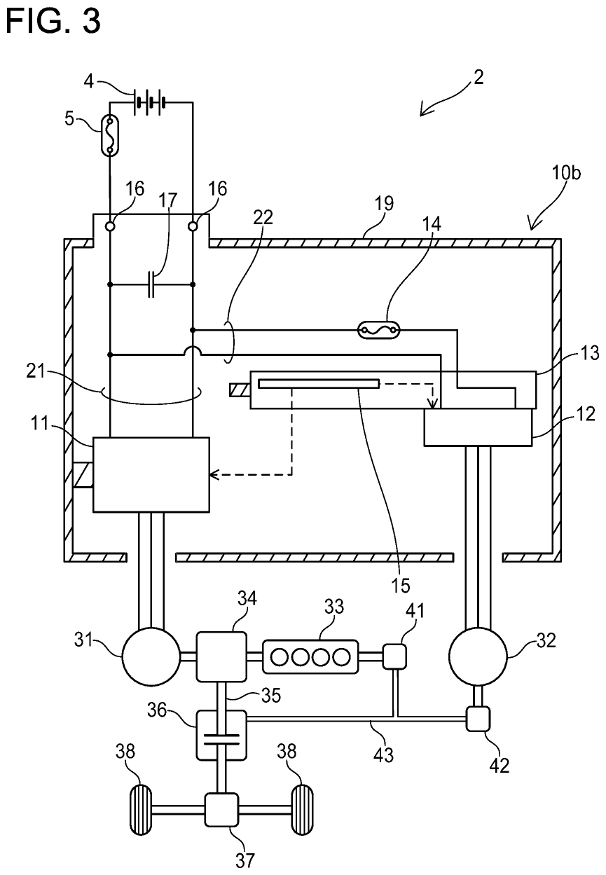

(Second Variant) FIG. 3 shows a power controller 10b of a second variant. In the power controller 10b, the fuse 14 is not fixed to the circuit board 13, but is incorporated in an intermediate portion of the auxiliary power line 22. Instead of the fuse 14, a relay switch may be incorporated in the auxiliary power line 22.

Features of the power controller 10 (10a, 10b) will be listed below. The power controller 10 (10a, 10b) includes the input terminal 16, the first inverter 11, the second inverter 12, and the fuse 14. The input terminal 16 is connected to the battery 4. The first inverter 11 and the second inverter 12 are both connected to the input terminal 16. The first inverter 11 is configured to convert the power of the battery 4 to the driving power for the electric motor for propulsion (the first electric motor 31). The second inverter is configured to convert the power of the battery 4 to the driving power for the second electric motor. The fuse 14 is a switch configured to electrically disconnect the second inverter 12 from the input terminal 16 and the first inverter 11. The fuse 14 disconnects the second inverter 12 in which a short circuit (failure) has occurred. As such, even when a short circuit (failure) occurs in the second inverter 12, the first electric motor 31 can be driven by the first inverter 11.

The maximum output current of the second inverter 12 is equal to or less than one-tenth of the maximum output current of the first inverter 11. Power supplied to the first inverter 11 does not flow in the fuse 14. The allowable current of the fuse 14 may be smaller than the maximum output current of the first inverter 11 (the allowable current of the main power line 21). The fuse 14, the allowable current of which is small, can be mounted on the circuit board 13. The control circuit 15 configured to control the first inverter 11 and the second inverter 12 is also mounted on the circuit board 13.

The first inverter 11, the second inverter 12, and the fuse 14 are housed in the housing 19 of the power controller 10 (10a, 10b).

The second electric motor 32 driven by the second inverter 12 is configured to drive the hydraulic pump (the second hydraulic pump 42) configured to control the clutch 36 between the first electric motor 31 and the wheels 38.

In the power controller 10a, the relay switch 14a, instead of the fuse 14, is incorporated in the circuit board 13. In the power controller 10b, the fuse 14 is not mounted on the circuit board 13, but is incorporated in the auxiliary power line 22 that connects the input terminal 16 and the second inverter 12.

Notes regarding the teaching described in the embodiment and its variants will be described. A switch configured to disconnect the second inverter 12 from the first inverter 11 and the input terminal 16 may be any of a fuse, a mechanical relay switch, and a semiconductor switch. The switch configured to disconnect the second inverter 12 from the first inverter 11 and the input terminal 16 may be mounted on a terminal block to which the input terminal 16 is fixed.

The second electric motor driven by the second inverter 12 may be a motor configured to drive a device other than a hydraulic pump. The DC power source connected to the input terminal 16 may be a fuel cell.

The power controller disclosed herein is suitably applied not only to hybrid vehicles but also to electric vehicles including no engine and electric vehicles including a fuel cell as the power source.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A power controller for an electric vehicle, the power controller comprising:
an input terminal connected to a DC power source;
a first inverter connected to the input terminal, the first inverter being configured to convert power of the DC power source to driving power for a first electric motor for propulsion;
a second inverter connected to the input terminal, the second inverter being configured to convert the power of the DC power source to driving power for a second electric motor; and
a switch configured to electrically disconnect the second inverter from the first inverter and the input terminal.

2. The power controller according to claim 1, wherein a maximum output current of the second inverter is equal to or less than one-tenth of a maximum output current of the first inverter.

3. The power controller according to claim 1, wherein the first inverter, the second inverter and the switch are housed in a housing.

4. The power controller according to claim 1, wherein the switch is a fuse.

5. The power controller according to claim 1, wherein the switch is mounted on a circuit board on which a control circuit configured to control the first inverter and the second inverter is mounted.

6. The power controller according to claim 1, wherein the switch is incorporated in a power line that connects the input terminal and a circuit board on which a control circuit configured to control the first inverter and the second inverter is mounted.

7. The power controller according to claim 1, wherein the second electric motor is configured to drive a hydraulic pump configured to control a clutch between the first electric motor and a drive wheel of the electric vehicle.
